(19) United States
(12) Patent Application Publication
(10) Pub. No.: US 2022/0091408 A1
(43) Pub. Date: Mar. 24, 2022

(54) METHOD, MICROSCOPE, AND COMPUTER PROGRAM FOR DETERMINING A MANIPULATION POSITION IN THE SAMPLE-ADJACENT REGION

(71) Applicant: Carl Zeiss Microscopy GmbH, Jena (DE)

(72) Inventors: Manuel AMTHOR, Jena (DE); Daniel HAASE, Zöllnitz (DE); Thomas OHRT, Golmsdorf (DE)

(21) Appl. No.: 17/404,006

(22) Filed: Aug. 17, 2021

(30) Foreign Application Priority Data
Sep. 18, 2020 (DE) 102020211699.7

(51) Int. Cl. G02B 21/36; G02B 21/26; G06T 7/80

(52) U.S. Cl. CPC G02B 21/367; G06T 7/80; G02B 21/26

(57) ABSTRACT

The invention relates to a method for determining a manipulation position of a microscope for a manipulation in the sample-adjacent region, and a microscope and a computer program for determining such a manipulation position.

To determine a manipulation position of a microscope for a manipulation in the sample-adjacent region, an overview image is recorded and evaluated as to whether at least one region is present at which a sample-adjacent manipulation can be performed. If this is the case, the precise manipulation position is sought out within a suitable region and a travel movement is determined to move an objective and/or a table of the microscope to the manipulation position.

The invention relates to a method for determining a manipulation position of a microscope for a manipulation in the sample-adjacent region, and a microscope and a computer program for determining such a manipulation position.

### BACKGROUND

Finding a sample is frequently a problem in microscopy, in particular for small phase objects. Therefore, attempts are made to enable faster orientation when finding the sample or a sample region of interest and therefore beginning experiments faster with the aid of calibrated overview images. For this purpose, after the positioning of a sample, an overview image is taken by means of an overview camera, which can be provided separately or can be arranged in an objective revolver of the microscope and linked to the position of the sample or the table (calibration).

Many experiments moreover require a manipulation in the region around the sample, for example the application of an immersion agent. For this purpose, a solution is required for how a user can perform this manipulation in the sample-adjacent region without removing the sample from the table and thus possibly losing an association between the overview image and the sample, which is important for the navigation with respect to the sample.

### OBJECT OF THE INVENTION

It is therefore the object of the invention to propose a solution for how a manipulation can be enabled in the sample-adjacent region, without moving the sample relative to the holding frame holding it or relative to the table of the microscope, wherein the accessibility for a user of the object to be manipulated is always ensured.

The object of the invention is achieved by a method as claimed in claim 1, a microscope as claimed in claim 14, and a computer program as claimed in claim 15. Further preferred embodiments of the invention result from the remaining features mentioned in the dependent claims.

### Solution

A method according to the invention for determining a manipulation position of a microscope for a manipulation in the sample-adjacent region comprises at least the following steps:
recording an overview image, in which a sample carrier and/or a sample carrier environment is at least partially visible,
evaluating the overview image by way of an image analysis to locate at least one suitable region in which a manipulation can take place in the sample-adjacent region,
when at least one suitable region has been located,
   determining a manipulation position within the at least one suitable region,
   determining a travel movement of an objective and/or a table of the microscope, wherein the travel movement specifies a movement of the objective and/or the table to a position at which the manipulation is to take place,
   moving the objective and/or the table of the microscope based on the previously determined travel movement,
   executing the manipulation in the sample-adjacent region after the movement of the objective and/or the table of the microscope.

A manipulation position is to be understood as a relative positioning of mobile or movable elements of the microscope in relation to one another and/or the microscope and its fixed components, so that at least one of the manipulations explained hereinafter can be executed at a location within this relative positioning. It is thus not a position on or in an object to be manipulated, but rather its arrangement relative to the microscope or to other movable microscope components, so that a user can execute the desired manipulation as easily and conveniently as possible.

For this purpose, if necessary, a positioning of one or more movable components is to be performed.

A sample-adjacent region can relate to both a region of the sample itself, or also a holding frame, a table, an objective, and the like, thus components which are typically to be found in the immediate environment of the sample.

Manipulation can be an addition of material, a removal of material, an adjustment of a component, or the like. The intention is to perform a change in the environment of the sample and/or on the sample. Specific applications will be explained with reference to the preferred embodiments.

In a first step, an overview image is recorded for this purpose, in which a sample carrier and/or a sample carrier environment is at least partially visible. This overview image can be recorded by means of a separate recording device, which is arranged, for example, in the form of a camera on the stand of the microscope, or also by means of the actual microscope camera. In comparison to microscopic images, an overview image also shows sample vessel walls or edges of the sample carrier and thus permits an overview of a sample in relation to its immediate environment. It can be both a raw image and also a further processed image, in particular also a detail of a recorded image.

The overview image is to show a sample carrier at least partially and/or a sample carrier environment for the method according to the invention, that is to say the sample was correspondingly prepared in any manner on a sample carrier and arranged on or in a sample carrier. A sample carrier can accommodate one or more samples. It can be formed with a carrier plate and one or more cover slips, or also as a chamber object carrier, as a petri dish, or as a microtitration plate. This sample carrier is positioned at the time of the recording of the overview image on the table of the microscope, so that the position of the sample or the sample carrier relative to the table can be acquired and assigned. This is referred to as calibration.

The overview image is evaluated by means of an image analysis in a next step to find at least one region at which a manipulation can take place in the sample-adjacent region. Thus, at least one location within the overview image is searched out, at which a sufficient accessibility for a manipulation and sufficient space to carry it out are present. In the simplest case, this can be a free region, it can also include, however, an opening, a feedthrough, or the like, through which a manipulation can take place. This at least one region does not already have to permit the manipulation in the positioning of the microscope components present in the overview image, but rather is used as a starting point for the following steps. It is self-evident that to determine the at least one suitable region it is to be previously known which manipulation is to be performed, since the type of the manipulation places various demands with respect to geometry and accessibility of the at least one suitable region and the manipulation position located therein.

For the image analysis itself, classical image analysis methods such as measuring, counting objects, inspecting the image, and/or reading out items of coded information can be applied. In one preferred embodiment, modern methods of image analysis can also be used, in particular image analysis by means of methods of machine learning. These are set forth in greater detail hereinafter as an optional embodiment.

If at least one suitable region for a sample-adjacent manipulation has been found, the specific manipulation position is determined within the at least one region. This comprises the suitable location or the most favorable position within the at least one suitable region, thus the precise position in this region, but also the arrangement or positioning of the microscope components, in particular the movable microscope components, in relation to one another.

To now determine the precise position and/or the arrangement of the microscope components in relation to one another, the precise location thereof has to be determined or taken into consideration. In the case of the position to be determined, at which the manipulation is to take place, for example in the form of the geometrical focal point of the suitable region. This can be produced by classical algorithms and/or geometrical calculations. The position of the microscope components is to be known from the microscopy system or is to be able to be determined by way of this or can also be determined from the overview image.

A travel movement of the microscope table and/or the objective of the microscope can be determined to move the table and/or the objective in such a way that it can be moved to the location ascertained for the manipulation position. Alternately a movement of only the table having the sample located thereon, only the objective, or both can be necessary to reach the manipulation position. The travel movement to be determined includes a direction of the required movements and/or a path length for the component(s) to be moved. It can also comprise a movement which first moves the objective and/or the table away from one another to obtain sufficient distance between them and enable a collision-free travel movement. The travel movement can take place in the X direction, Y direction, and/or Z direction, wherein the X direction and the Y direction span a plane identical to the sample plane or at least approximately parallel thereto and the Z direction is oriented perpendicularly thereto.

If the travel movement is known, the table and/or the objective is moved to the predetermined position, specifically by the amount specified by the predetermined travel movement and/or the specified direction. The desired manipulation can then be performed in the sample-adjacent region. If desired or necessary, the moving components can then be moved into the observation position.

If no travel movement is necessary, because the manipulation position already exists in the present configuration of the microscopy system, this step can be omitted, and it can be signaled to the user that he can perform his manipulation.

In a corresponding manner, a microscopy system for determining a manipulation position of a microscope for a manipulation in the sample-adjacent region comprises a microscope which is configured to record an overview image, wherein a sample carrier and/or a sample carrier environment is at least partially visible in the overview image. As already stated, the recording can be carried out by means of a separate overview camera or a camera provided in the microscope in any case. The microscope can be in particular a light microscope, an x-ray microscope, an electron microscope, a macroscope, or also another suitably designed magnifying image recording device which is configured to record images (microscope images).

Moreover, the microscopy system comprises a processing device, which is designed and provided to evaluate the overview image by means of image analysis in order to locate at least one region suitable for a manipulation, determine a manipulation position within the at least one suitable region and a travel movement, wherein the travel movement includes the movement of the objective and/or the table of the microscope to reach the manipulation position.

The processing device can be provided as part of the microscope or as a separate device. It can be arranged in the surroundings of the microscope or at any other location. The data communication between the microscope and the processing device, which can take place in a wireless or wired manner, is essential. The processing unit can be formed by any suitable combination of electronics and software and in particular can comprise a computer, a server, a cloud-based computer system, or one or more microprocessors or graphics processors. It can moreover also be configured for the control of the microscope camera, the image recording, the sample table control, and/or the control of other microscope components.

A computer program for determining a manipulation position of a microscope for a manipulation in the sample-adjacent region comprises commands which effectuate the execution of the method according to the invention upon execution of the program by a computer or a microscopy system. In particular, the computer program comprises the following steps: obtaining an overview image, in which a sample carrier and/or a sample carrier environment is at least partially visible, evaluating the overview image by means of an image analysis to locate at least one suitable region in which a manipulation can take place in the sample-adjacent region, determining a manipulation position within the at least one suitable region, and determining a travel movement of an objective and/or a table of the microscope, wherein the travel movement specifies a movement of the objective and/or the table to a position at which the manipulation is to take place.

### OPTIONAL EMBODIMENTS

In a first optional embodiment of the method according to the invention, a manipulation in the sample-adjacent region comprises applying an immersion medium, cleaning a front lens on an objective, modifying an objective, adjusting a DIC slider, attaching or removing an exchangeable component, cleaning a surface, inscribing the sample carrier, and/or attaching a marker.

The application of an immersion medium can be both an initial immersion, thus an initial application of an immersion medium, or also a re-immersion, thus a reapplication of immersion medium. The immersion medium can be applied to the sample or to the objective, depending on the embodiment of the microscope as an upright or inverse microscope. For this purpose, the table with the sample and/or the objective can be traversed or moved in relation to the manipulation position in such a way that a convenient and undisturbed supply of the immersion medium is enabled.

If soiling of the front lens is recognized in the microscope, cleaning can be necessary, which can be effectuated, for example, by flushing using the immersion medium. The manipulation position required for this purpose can correspond to that during the application of the immersion medium or can also differ from it.

A further manipulation can be a modification of the objective of the microscope. Such a modification can consist by way of example of the change of correction ring settings, or also in the setting of the immersion in the case of multi-immersion objectives. In a preferred manner, for this purpose the objective is moved to a position at which a user has the simplest possible access to the objective, without inadvertently adjusting or shifting other components in the environment or even the sample at the same time.

Furthermore, the attachment or removal of exchangeable components in the environment of the sample can be such a manipulation, since the attachment or removal of the exchangeable component has to take into consideration the previous sample arrangement and orientation.

As already mentioned, an overview image can be recorded by means of a camera and a mirror. This mirror can possibly become soiled, so that cleaning becomes necessary. Other surfaces in the environment of the sample can also require cleaning to avoid influencing the observation results.

The adjustment of a DIC slider to observe phase objects, thus the introduction into or the removal from the beam path is also included among the manipulations in the sample-adjacent region, as is the application of an inscription to the sample carrier or the attachment of markers for navigation to the sample.

In another embodiment of the method, it is provided that the image analysis is carried out by a machine learning model of a computer program, which locates in the overview image the at least one region suitable for a manipulation in the sample-adjacent region.

The machine learning model is a system which generates a statistical model by means of algorithms from an input set of training data, which model depicts recognized categories and relationships from the training data. In the present method, the training data are overview images in which sample carriers and/or sample carrier environments are at least partially contained. On the basis of these training overview images, the machine learning model learns whether and where a sample carrier or sample carrier environment, in particular also elements of the sample carrier environment, are present. It also learns therefrom where free regions are located, thus where no sample carrier or where no sample carrier environment is present. These free regions are very probably suitable for a manipulation in the sample-adjacent region.

The sample carrier environment can be characterized by a number of elements, which can include, for example, holding frames or holding frame parts, webs of the holding frame, and the like.

Holding frames sometimes have movable webs, which are to be adapted to the geometry of the sample carrier, so that the sample carrier is held between them. An inference of the location of the sample and free regions located around it is also possibly enabled by way of the knowledge of the sample carrier environment and its location.

The machine learning model can contain at least one neural network, in particular at least one neural network of so-called deep learning (DL), furthermore preferably at least one convolutional neural network (CNN). Multiple neural networks can also be provided, which execute individual processing steps in succession, in which the outputs of the one network thus form the input values of another network. If multiple interacting neural networks are used in a machine learning model, the individual neural networks can each also be referred to as a machine learning model or as a submodel.

The neural network or the neural networks can be trained by monitored learning, unmonitored learning, partially monitored learning, or reinforcement learning. Unmonitored learning is particularly suitable for segmenting. Monitored learning can be used for classification, for example, wherein the training overview images are provided with class designations or target data. For example, one class can designate the sample carrier and multiple other classes can designate various holding frames, holding frame parts, or exchangeable components. In partially monitored learning, only a part of the training images is annotated, for example, a known classification is only entered in a part of the training images.

If at least one free region, which is therefore suitable for a sample-adjacent manipulation, is found, its precise location has to be determined as already described. This can alternately be carried out by the or one machine learning model, or, as already explained, by classical algorithms without machine learning models.

The advantage of the use of a machine learning model is above all in its robustness, since it can generally compensate for small changes or disturbances in the overview image, so that they do not result in errors. Moreover, new elements of the sample carrier environment or a general reconfiguration of the sample carrier environment can easily be supplemented by a new training pass. In comparison thereto, the effort which has to be made in classical image analysis to compensate for such disturbances and/or changes is very high, since the changes possibly influence the recognition of known elements and environments.

Alternatively, or additionally, the determination of the manipulation position can be carried out by a machine learning model of a computer program, which ascertains the manipulation position in a region judged to be suitable. A machine learning model is thus trained here in such a way that it determines the actual manipulation position on the basis of the suitable region for carrying out a manipulation in the sample-adjacent region, which is determined previously in a classical way or by a machine learning model. This model, as was stated with respect to the model for determining the at least one suitable region, can contain at least one neural network, in particular at least one neural network of deep learning, and furthermore preferably at least one convolutional neural network trained by means of the above-explained methods.

For the training to determine the manipulation position by means of machine learning model, items of information such as geometrical boundary conditions and relationships, a geometrical description of the previously determined suitable region and the like, and/or training overview images in which at least one suitable region is already located, can be used for the training. By way of the training, the machine learning model learns where locations suitable for the manipulation in the sample-adjacent region are within the previously determined suitable region and which boundary conditions they are dependent on. These include, inter alia, the available space around a potential manipulation position, but also its accessibility for a user with his handling means or in the case of an automation for the components which cooperate in the manipulation.

The machine learning model for determining the at least one suitable region for a manipulation in the sample-adjacent region and the machine learning model for determining the manipulation position can be designed as separate machine learning models, however, in one advantageous embodiment of the method according to the invention, a common machine learning model of a computer program can also be provided, which is trained in such a way that it determines a travel movement from an overview image. This procedure is generally referred to as end-to-end learning and is implemented in particular by deep learning models. The common machine learning model can include, for example, two submodels, which correspond to the above-explained machine learning models. However, it can also be embodied as a single machine learning model having one or more neural, in particular convolutional neural networks, which interact to fulfill the object.

It can be provided that the machine learning model carries out the locating of at least one region suitable for a manipulation and/or the determination of the manipulation position in one of the following ways:
with the aid of a segmentation, in which it is marked in the overview image which regions are suitable for a manipulation in the sample-adjacent region,
with the aid of a classification or semantic segmentation, wherein a differentiation is made between suitable and unsuitable regions for a manipulation in the sample-adjacent region,
with the aid of a detection of suitable and unsuitable regions,
with the aid of a classification in which an objective type, a table type, a holding frame type, and/or a sample carrier type is identified, wherein respective geometrical positions are stored, by means of which the travel movement is determined.

The respective machine learning model, thus alternately the machine learning model for locating a suitable region, the machine learning model for determining the manipulation position, or the common machine learning model can evaluate the overview image using various methods. Depending on the embodiment having one or more or a common machine learning model(s), each thereof can achieve its object with one or more of the methods listed here.

A first variant is that a segmentation is carried out, by which it is marked in the overview image or a detail thereof which image regions are suitable for a manipulation in the sample-adjacent region. The remaining image regions can be characterized as unsuitable regions or objects shown therein can be assigned to the sample carrier, the sample, and/or the sample carrier environment. As the output of this evaluation, an image can be produced in which various pixel values identify various regions or segments. Alternatively, a segmentation output can also be produced by a vector graphic or object position specifications.

In a second variant, a classification or a semantic segmentation can be used to differentiate between suitable and unsuitable regions for a manipulation in the sample-adjacent region. The sample carrier and the sample carrier environment or the components of the sample carrier environment are characterized, inter alia, by the relative position thereof in relation to one another and the geometry thereof in the overview image. To judge whether or not a region is suitable for a manipulation in the sample-adjacent region, not only its location, but also its type thus has to be determined. This has effects on the manipulation position and the travel movement to be determined later, which can differ in dependence on the location and the type of sample carrier, sample carrier environment, and its components.

The classification can moreover be used to identify the sample carrier and/or the components of the sample carrier environment. Therefore, no longer are only its presence and/or position known, but rather also the specific type. In the training of the respective machine learning model, the components to be recognized are present with various types of the possibly occurring components in the training images. In each case a specific model or a group of similar models of a component can be understood as a type. Geometrical data and possibly items of context information are then stored for each type, so that these can be used in the determination of the travel movement.

For example, objective type, a table type, a holding frame type, and/or a sample carrier type can be classified or semantically segmented. The stored geometrical data can contain, inter alia, target positions, at which the recognized object or the associated type is typically positioned, possibly also in relation to other components and objects.

It may now be differentiated from the items of information thus ascertained where a region is suitable for the manipulation and where it is not, but also whether, for example, a manipulation position is settable by a travel movement of one component or multiple components or also the sample carrier together with the table, so that as a result the travel movement can be determined.

Finally, the assessment of suitable and unsuitable regions can also be carried out by means of a detection of predetermined elements of the overview image, thus of sample carrier and/or sample carrier environment. Outlines, edges, corners, fastening means, or markings of sample, sample carrier, and/or sample carrier environment can be detected. Markings can comprise inscriptions or stickers.

Location relations in relation to one another may be derived from the determination of suitable and unsuitable regions for the manipulation in the sample-adjacent region and the determination of individual components in the environment, or such location relations can also be previously known. Furthermore, constraint points and/or boundary regions for the travel movement can also result therefrom, which are to be incorporated in the determination thereof. It is also possible by way of such relationships to conclude the sample carrier environment outside the overview image or regions of the sample carrier outside the overview image and also to incorporate these inferences in the determination of the travel movement.

In the evaluation of the overview image, according to the invention, at least one region suitable for a manipulation in the sample-adjacent region is sought out. If two or more such suitable regions are located, a selection of the region has to take place, in which the manipulation is to take place. This can be carried out, for example, in that the region having the largest area in the manipulation plane, the largest diameter, or the largest spatial content is selected. The located regions are thus compared with respect to the area content thereof in the manipulation plane, thus the plane in which the manipulation in the sample-adjacent region is to take place, the diameter thereof, or the volume thereof. The region which forms the maximum in the checked criterion here is selected as the best suitable region.

In an alternative thereto, the located regions are displayed to a user, so that he can assess the accessibility thereof individually. On the basis of these assessments, a best accessible region can be selected. The assessment of the displayed regions can moreover be stored to use it for comparable applications. The interaction with the user can be carried out via a separate processing unit of the microscopy system or a processing unit connected thereto and in particular with the aid of its display devices.

In a further alternative, the located regions can also be displayed to the user for selection, and he directly selects the region in which he wishes to perform the manipulation. He does not output an assessment of the accessibility in this case, but rather directly selects the respective region. He can also incorporate individual, that is to say subjective criteria here, for example personal movement restrictions or if he wishes to execute the manipulation so that a spectator can also view it.

The assessment of multiple suitable regions can also be carried out, however, by a machine learning model of a computer program. This can be the machine learning model for determining the at least one suitable region, that for determining the manipulation position, or the common machine learning model. However, it can also be a separate machine learning model exclusively for the assessment of the located regions for the sample-adjacent manipulation. The basis for the assessment in the training process can be geometrical boundary conditions, but optionally also the consideration of items of user and/or context information, as are explained hereinafter. The assessment can also take place in the context of lifelong learning, in which the respective machine model learns the assessment on the basis of the selection by a user.

One preferred embodiment of the method according to the invention includes that to locate at least one suitable region, to assess multiple located regions, and/or to determine the manipulation position, one or more of the following items of context information
the presence or absence of exchangeable components of the microscope,
the type and size of exchangeable components of the microscope,
the presence or absence of an incubator,
the type of the stand,
the type of an immersion medium,
the type of the manipulation tool,
the type and parameters of the observation task,
the quality of the workspace,
the illumination conditions at the workspace,
the examined type of sample,
a microscopic image from the experiment,
the type and quality of the table,
   and/or the following items of user information
the handedness of a user,
an ascertained preference of a user,
a prior correction and/or selection of a user with respect to a determined travel movement are taken into consideration. The locating of the at least one suitable region, the assessment in the case of multiple suitable regions and/or the determination of the manipulation position are also to incorporate additional criteria in order to optimize their results and adapt them to changeable conditions.

Locations and number of suitable regions for a sample-adjacent manipulation can vary in dependence on various exchangeable components, since the size, the position, and their presence or absence limit the available areas or spaces for a manipulation or at least make them impossible in regions. For this purpose, for example, geometrical data from the design data of the respective exchangeable components can be used. The exchangeable components can be listed, non-exhaustively, as exchangeable objectives, sample holders, illumination modules, polarization filters, lenses, gratings, user-specific add-ons, and filter inserts. This also applies for the type of the stand, the type and quality of the table, and the presence or absence of an incubator, whereby, for example, the mobility and the distances they can be covered by the table are influenced. The manipulation tool can also play a significant role since its size and shape have effects on whether a manipulation position is accessible and whether the manipulation can be executed safely and correctly there. Such a manipulation tool can be, for example, an immersion tool. In the course of this, it is also reasonable to take into consideration the type of the immersion medium, which has influence on the type of its application.

The quality of the workspace and/or the illumination conditions at the workspace can also influence the manipulation in the sample-adjacent region. Quality of the workspace is to be understood predominantly, but only by way of example, as the spatial conditions and the accessibility in the surroundings of the microscope, on which it can be dependent as to whether a user can reach a manipulation position. It can thus also possibly result that an accessibility of the manipulation position is simplified by approaching it from another direction different from the observation position. The light conditions at the workspace have the effect that the shading induced by them can impair the visibility of a manipulation position. Too little illumination also results in worse visibility, while very strong illumination can result in undesired reflections and appearances of dazzling.

The type of the sample examined and the type and parameters of the experiment to be carried out can advantageously be used as items of context information, since geometrical and organizational dependencies and specifications arise due to them. These can restrict the performance of a manipulation in the sample-adjacent region. The parameters include, for example, the duration of the experiment, required temperatures, required illumination conditions during the observation, and the like.

A microscopic image from the experiment, thus a recording which was recorded after the creation of the overview image, can also provide items of context information, for example relevance regions of the sample, the usability of individual regions of the sample, contaminants on the sample carrier, or the precise position of a region of interest of the sample.

Further items of context information are possible and can alternatively or additionally be incorporated into the locating of the at least one suitable region, the assessment in the case of multiple regions, and/or the determination of the manipulation position.

In addition to the items of context information, which are person-independent, items of user information can be taken into consideration. These are to be items of information which relate to the user who presently interacts with the microscope. These include, inter alia, whether he is right-handed or left-handed. This is because the user will differentiate or not be able to perceive in dependence thereon the accessibility to the manipulation position to be able to perform a correct and safe manipulation. At this point, assessments previously input by the respective user, a selection and changes and corrections which he has performed after the determination of the manipulation position and/or after completion of the travel movement, can also be incorporated into the renewed locating of the at least one suitable region, the assessment in the case of multiple suitable regions, and/or the determination of the manipulation position. Of course, these have to have been acquired and stored beforehand. The acquisition can take place here, for example, in the form of a query. In the simplest case, the last performed correction of the user can also simply be taken from his last interaction. However, so-called lifelong learning can also be provided, in which the respective machine model or the respective machine learning models learn the user-specific items of information. This lifelong learning can alternatively or additionally also be provided for the items of context information. The preference of a user for special system structures may thus also be acquired and incorporated, for example.

The use of items of context information and/or user information can improve the locating of the at least one suitable region, the selection of the best of multiple suitable regions, and/or the determination of the manipulation position and can also contribute to avoiding collisions or more difficult accessibilities. The implementation can preferably be carried out by optimization methods. Geometry and location of the suitable regions, the position-dependent manageability or accessibility, and the like are depicted in a cost function, which is minimized for locating the at least one suitable region, the assessment in the case of multiple suitable regions, and/or for the determination of the manipulation position.

The components to be moved, thus the table and/or the objective of the microscope, are to be moved on the basis of the travel movement determined in the method according to the invention. This can be carried out automatically based on the determined travel movement and upon the presence of a corresponding motorization of the components. If such movement units are not provided, the required travel movement can also be indicated to a user, so that he can adjust the table and/or the objective manually in path length and direction. A new overview image can then optionally be taken in each case, to compare the occurring movement to the previously determined required movement and to enable or propose corrections if necessary.

In addition to the movement of the objective and/or the table, it can be necessary to move motorized components which are to be brought into contact with the sample or are already in contact with the sample to enable a desired manipulation in the sample-adjacent region. For this purpose, a travel movement also has to be determined for these components, which can subsequently be executed automatically. The determination of the travel movement itself is carried out analogously to the determination of the travel movement for the objective and/or the table. By way of example, moving electrodes, manipulation needles, and holding needles are mentioned as such components.

An adaptation of the travel movement of the motorized components which are in contact or are to be brought in contact with the sample in accordance with the movement of the table and/or the objective can possibly be necessary, so that the travel movements are checked with one another for a possible collision.

It can therefore be advantageous, before the movement of the objective of the microscope, the table of the microscope, and/or motorized components which are to be brought into contact with the sample or are already in contact with the sample, to compare the resulting position of the objective, table, and/or the motorized components with stored permitted position regions and to output a warning if the resulting position of the objective, the table, and/or the motorized components lies outside the permitted position region. This can take place independently of whether the travel movement is executed automatically or manually.

The permitted position or the permitted position range is restricted, for example, by possible collisions of the microscope components. For this purpose, the geometry and position of the components present in the surroundings of the movable components are used. The movement of multiple components to reach a manipulation position can also result in restrictions of the movement paths and thus the permitted ranges. If the resulting position of the objective and/or the table lie outside the respective permitted ranges, a warning can be output so that it is possible for the user to perform manual changes. These changes can be, inter alia, the rearrangement of the sample carrier, which requires a recalibration and a restart of the method, however. The removal of exchangeable components during the method and the performance of the manipulation can also be such a manual change.

If the travel movement is executed, the desired manipulation takes place in the sample-adjacent region. The manipulation can preferably take place as an automatic manipulation and in particular can be an automatic immersion. Corresponding automation means, which perform a manipulation without intervention of the user, have to be present for this purpose in dependence on the manipulation to be performed. In the case of immersion, this is an autoimmersion device, which is activated after completion of the travel movement to apply the immersion medium.

If no region which is suitable for a sample-adjacent manipulation is found during the method according to the invention, this information has to be transmitted to a user. This can be carried out, for example, by means of a warning message, in which the warning is transmitted visually and/or acoustically. A warning message can thus be displayed on a display device of the microscopy system or a processing unit connected thereto and/or it can sound a warning tone.

The various embodiments of the invention mentioned in this application are advantageously combinable with one another, if not stated otherwise in the individual case. The properties of the invention described as additional device features also result in variants of the method according to the invention upon use as intended. Vice versa, the microscopy system can also be configured to execute the described method variants. In particular, the processing device can be configured to carry out the described method variants and to output control commands to execute the described method steps. Moreover, the processing device can comprise the described computer program.

Variants of the computer program according to the invention result in that the computer program comprises commands for executing the described method variants.

### DESCRIPTION OF THE FIGURES

The invention is explained hereinafter in exemplary embodiments on the basis of the associated drawings. In the figures:

FIG. 1 shows a schematic sketch of an inverse microscope having an overview camera, and

FIG. 2 shows a schematic illustration of the sequence of the method according to the invention in an exemplary embodiment.

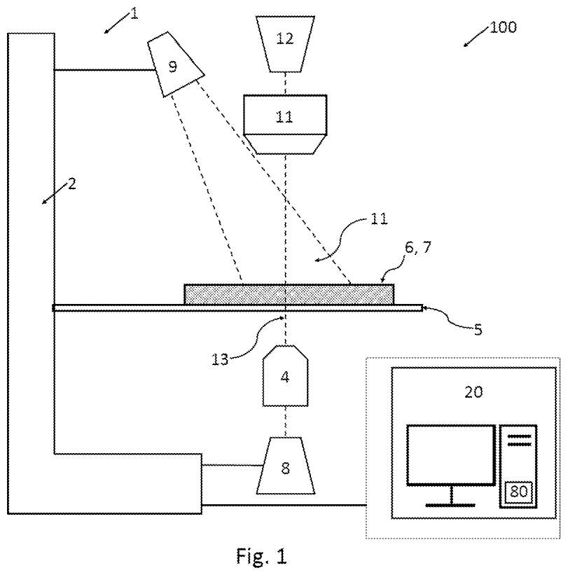

FIG. 1 schematically shows an exemplary embodiment of a microscope 1 according to the invention. The microscope 1 comprises a light source 12 and a condenser 11 for illuminating a sample 7 arranged in a sample carrier 6, which is positioned on a sample table 5.

Detection light originating from the sample 7 is conducted along an optical axis 13 having an objective 4 for recording a sample image to a camera 8. The objective can be held in an objective revolver 3 (not shown).

An overview camera 9 is held on the microscope stand 2, using which an overview image 30 of the sample 7 can be recorded. In an alternative embodiment, it can also be provided that the overview camera 9 records the overview image 30 via a mirror (not shown).

A processing device 20 is configured to process a recorded microscopic image (that is to say a sample image or overview image), inter alia, to determine a manipulation position for a manipulation in the sample-adjacent region from the overview image 30 and therefrom a travel movement 60 to the same.

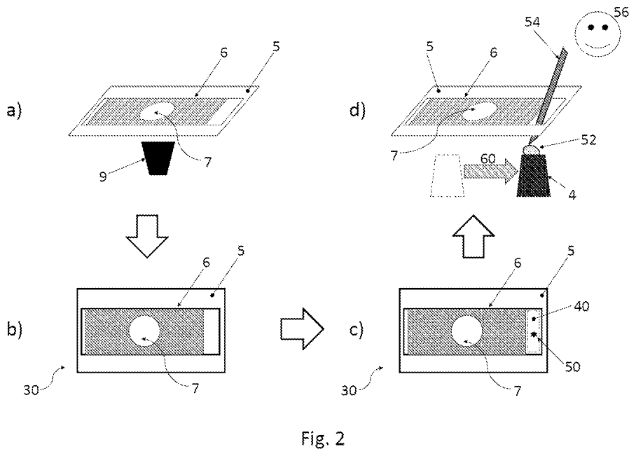

The processing device 20 is configured to carry out the steps described with reference to FIG. 2, as explained hereinafter.

The processing device 20 can also be used in another microscope, which in contrast to the illustrated microscope, for example, operates according to another measurement principle or is a scanning or electron microscope. A processing device as described here can also be provided for image analysis in devices other than the microscope.

FIG. 2 schematically shows a sequence of the method according to the invention. The sequence direction is indicated by means of arrows. In this solely exemplary embodiment, a manipulation position 50 is to be found, at which an immersion medium 52 can be applied to the front lens of the objective 4 using an immersion tool 54. In order to set this, the table 5 of the microscope 1 and/or its objective 4 can be moved.

In FIG. 2a, a sample carrier 6 with a sample 7 is laid on a sample table 5. Using an overview camera 9, which can be arranged, for example, in an object revolver 3 (not shown) of the microscope 1, an overview image 30 is recorded (FIG. 2b). The overview image 30 shows the table 5, the sample carrier 6, and the sample 7 in a bottom view. Accordingly, sample carrier 6 and sample carrier environment are at least partially visible in the overview image 30.

An image analysis follows to determine whether and possibly where there are suitable regions 40 at which an immersion can take place. Since the immersion medium 52 has to be applied to the objective 4, a region 40 is sought out in which a user 56 can guide an immersion tool 54 to the objective 4 and can apply the immersion medium 52. Alternatively, such a region 40 is to be found to automatically apply an immersion medium 52 using an autoimmersion device (not shown).

The image analysis with respect to finding at least one suitable region 40 is carried out by means of a machine learning model, which is trained so that by means of segmentation of the overview image 30, it differentiates regions in which the sample carrier 6, the table 5, or other objects are located, thus occupied regions, and free regions, in which no objects are located or which can be made free by the movement of movable objects. These free regions are suitable regions 40 for a manipulation in the sample-adjacent region, in this example thus an immersion. The machine learning model includes in this exemplary embodiment a convolutional neural network, which is provided for locating at least one suitable region 40 and is trained using training overview images, which at least partially contain sample carriers 6 and/or sample carrier environments.

It is apparent from FIG. 2c that free regions exist between sample carrier 6 and table 5 on the left and right of the sample carrier 6. However, only one region 40 is identified as suitable. This is because the suitable region 40 is determined on the basis of the manipulation to be carried out (here: immersion) and in consideration of possible geometrical dependencies, items of context information such as the presence of exchangeable components, table type, and sample carrier type, and in consideration of permitted position regions. The permitted position regions describe the locations to which a movable object such as a table 5 or an objective 4 can be moved without collisions occurring with one another and/or with other objects of the microscope components. They preferably contain type-dependent geometrical dependencies, which are used to establish the permitted regions.

In consideration of the various influencing variables together, the region to the left of the sample carrier 6 would be too narrow and also difficult to access for a right-handed person, for example. It is therefore not suitable and is accordingly also not identified as a suitable region 40.

In the present exemplary case, only one suitable region 40 is present. In contrast, if multiple suitable regions 40 had been ascertained, either a selection of the preferred region or an assessment of the individual regions 40 would have to be carried out by the user 56. Alternatively, an assessment could also be carried out by the machine learning model which is located the suitable regions 40. For such an assessment, in addition to the above-mentioned items of context information, a consideration of items of user information, which comprise, for example, the handedness of the user 56 or his preferred access paths to a manipulation position 50, is also helpful.

A manipulation position 50 is also identified in the overview image 30 in FIG. 2c. By way of example, this is located in the center of the region 40 judged to be suitable. The determination of the manipulation position 50 in the suitable region 40 can be carried out by determination of the center point or the area focal point, however, a further machine learning model can also be provided, which on the basis of the output of the first machine learning model, using which the suitable region 40 was determined, in this region 40 ascertains the manipulation position 50 in consideration of items of context and user information, geometrical boundary conditions (permitted regions), and the like. Alternatively, thereto, the determination of the manipulation position 50 can also be determined in a common machine learning model with the suitable regions 40.

In addition to finding the suitable regions 40 and/or the manipulation position 50, the effort for setting the manipulation position 50 is to be kept as low as possible, i.e., the number of the components table 5 and/or objective 4 to be moved is to be as small as possible and the movement distances are to be as short as possible to keep the duration until reaching the manipulation position 50 low. For this purpose, a cost function is implemented, which depicts the geometry and location of suitable regions 40, the position-dependent manageability or accessibility, and the like in a cost function and which is minimized to assess the suitable regions 40 and/or to determine the manipulation position 50. As a consequence, it can result that only the table 5 or only the objective 4 is to be moved to set the manipulation position 50.

After the manipulation position 50 is known, the travel movement 60 has to be determined in order to bring at least the table 5 and the objective 4 into a relative position in relation to one another so that the immersion can actually also be applied at the location of the manipulation position 50. It was determined beforehand by means of the above-described cost function that only the objective 4 has to be moved. It is now determined how far and in which direction the objective 4 has to be moved. This can also comprise a movement which first moves the objective 4 downward to obtain sufficient distance from the table 5 and enable a collision-free travel movement.

In the present case, the travel movement 60 of the objective 4 is executed automatically and the objective is moved to the manipulation position 50 (FIG. 2d). If the travel movement 60 is completed, the user 56 can apply the immersion medium 52 to the front lens of the objective 4 using the immersion tool 54. The objective can subsequently first be moved in the horizontal direction (X-Y direction) to the desired observation position and can subsequently be moved toward the sample in the vertical direction (Z direction).

### LIST OF REFERENCE NUMERALS

1 microscope
2 stand
3 objective revolver
4 microscope objective
5 sample table
6 sample carrier
7 sample
8 microscope camera
9 overview camera
10 field of view of the overview camera
11 condenser
12 light source
13 optical axis
20 processing device
30 overview image
40 suitable region
50 manipulation position
52 immersion medium
54 immersion tool
56 user
60 travel movement
80 computer program of the invention
100 microscopy system of the invention

1. A method for the determination of a manipulation position of a microscope for a manipulation in the sample-adjacent region, comprising
recording an overview image, in which a sample carrier and/or a sample carrier environment is at least partially visible,
evaluating the overview image by way of an image analysis to locate at least one suitable region in which a manipulation can take place in the sample-adjacent region,
when at least one suitable region has been located:
determining a manipulation position within the at least one suitable region,
determining a travel movement of an objective and/or a table of the microscope, wherein the travel movement specifies a movement of the objective and/or the table to a position at which the manipulation is to take place,
moving the objective and/or the table of the microscope based on the previously determined travel movement,
executing the manipulation in the sample-adjacent region after the movement of the objective and/or the table of the microscope.

2. The method as claimed in claim 1, wherein a manipulation in the sample-adjacent region comprises applying an immersion medium, cleaning a front lens on an objective, modifying an objective, adjusting a DIC slider, attaching or removing an exchangeable component, cleaning a surface, inscribing the sample carrier, and/or attaching a marker.

3. The method as claimed in claim 1, wherein the image analysis is carried out by a machine learning model of a computer program, which locates the at least one region suitable for a manipulation in the sample-adjacent region in the overview image.

4. The method as claimed in claim 1, wherein the determination of the manipulation position is carried out by a machine learning model of a computer program, which ascertains the manipulation position in a region judged to be suitable.

5. The method as claimed in claim 1, wherein the locating of at least one region suitable for a manipulation and the determination of the manipulation position take place in a common machine learning model of a computer program, which is trained to determine a travel movement from an overview image.

6. The method as claimed in claim 3, wherein the machine learning model comprises at least one convolutional neural network, which
is provided for locating at least one suitable region and is trained using training overview images, which at least partially contain sample carriers and/or sample carrier environments, and/or
is provided for determining the manipulation position and is trained using items of training information with respect to at least one suitable region and/or training overview images, in which at least one suitable region is located.

7. The method as claimed in claim 1, wherein the machine learning model carries out the locating of at least one region suitable for a manipulation and/or the determination of the manipulation position in one of the following ways:
with the aid of a segmentation, in which it is marked in the overview image which regions are suitable for a manipulation in the sample-adjacent region,
with the aid of a classification or semantic segmentation, wherein a differentiation is made between suitable regions and unsuitable regions for a manipulation in the sample-adjacent region,
with the aid of a detection of suitable regions and unsuitable regions,
with the aid of a classification, in which an objective type, a table type, a holding frame type, and/or a sample carrier type are identified, wherein in each case geometrical positions are stored, by means of which the travel movement is determined.

8. The method as claimed in claim 1, wherein if multiple regions suitable for a manipulation are present in the sample-adjacent region
the region having the largest area in the manipulation plane, the largest diameter, or the largest spatial content is selected, or
these regions are assessed with respect to their accessibility by a user and a best accessible region is selected, or
the suitable regions are displayed to a user for selection, or
a best accessible region is selected by a machine learning model of a computer program.

9. The method as claimed in claim 1, wherein for locating at least one suitable region, for assessing multiple located regions, and/or for determining the manipulation position, one or more of the following items of context information
the presence or absence of exchangeable components of the microscope,
the type and size of exchangeable components of the microscope,
the presence or absence of an incubator,
the type of the stand,
the type of an immersion medium,
the type of the manipulation tool,
the type and parameters of the observation task,
the quality of the workspace,
the illumination conditions at the workspace,
the examined type of sample,
a microscopic image from the experiment,
the type and quality of the table,
and/or the following items of user information
the handedness of a user,
an ascertained preference of a user,
a prior correction and/or selection of a user with respect to a determined travel movement
are taken into consideration.

10. The method as claimed in claim 1, wherein
the movement of the objective and/or the table of the microscope is carried out automatically based on the previously determined travel movement, or
the travel movement is output to a user for the manual adjustment of the objective and/or the table of the microscope.

11. The method as claimed in claim 1, wherein the determination of a travel movement includes a movement of a motorized component which is in contact or is to be brought into contact with the sample.

12. The method as claimed in claim 1, wherein before the movement of the objective, a table, and/or a motorized component in contact or to be brought into contact with the sample, the resulting position of the objective, the table, and/or a motorized component is compared to stored permitted position ranges and a warning is output if the resulting position of the objective, the table, and/or a motorized component is outside the permitted position range.

13. The method as claimed in claim 1, wherein the execution of the manipulation, in particular an immersion, is carried out automatically.

14. The method as claimed in claim 1, wherein a warning message is transmitted to a user if a region suitable for a manipulation in the sample-adjacent region cannot be located.

15. A microscopy system for the determination of a manipulation position of a microscope for a manipulation in the sample-adjacent region, comprising
a microscope, which is configured to record an overview image, in which a sample carrier and/or a sample carrier environment is at least partially visible,
a processing device, which is configured
to evaluate the overview image by means of an image analysis to locate at least one suitable region, in which a manipulation can be carried out in the sample-adjacent region,
to determine a manipulation position within the at least one suitable region, and
to determine a travel movement of an objective and/or a table of the microscope, wherein the travel movement specifies a movement of the objective and/or the table to a position at which manipulation is to take place.

16. A computer program for the determination of a manipulation position of a microscope for a manipulation in the sample-adjacent region, comprising
obtaining an overview image, in which a sample carrier and/or a sample carrier environment is at least partially visible,
evaluating the overview image by means of an image analysis, to locate at least one suitable region, in which a manipulation can take place in the sample-adjacent region,
determining a manipulation position within the at least one suitable region, and
determining a travel movement of an objective and/or a table of the microscope, wherein the travel movement specifies a movement of the objective and/or the table to a position at which the manipulation is to take place.
